(19) United States
(12) Patent Application Publication
(10) Pub. No.: US 2024/0007885 A1
(43) Pub. Date: Jan. 4, 2024

(54) METHOD FOR SENDING MEASUREMENT PACKET AND COMMUNICATION APPARATUS

(71) Applicant: HUAWEI TECHNOLOGIES CO., LTD., Shenzhen (CN)

(72) Inventors: Chenchen LIU, Shenzhen (CN); Xiao HAN, Shenzhen (CN); Rui DU, Shenzhen (CN); Meihong ZHANG, Shenzhen (CN); Yingxiang SUN, Shenzhen (CN)

(73) Assignee: HUAWEI TECHNOLOGIES CO., LTD., Shenzhen, GD (CN)

(21) Appl. No.: 18/366,107

(22) Filed: Aug. 7, 2023

Related U.S. Application Data
(63) Continuation of application No. PCT/CN2022/074281, filed on Jan. 27, 2022.

(30) Foreign Application Priority Data
Feb. 9, 2021 (CN) 202110178784.7

(51) Int. Cl. H04W 24/08

(52) U.S. Cl. CPC H04W 24/08

(57) ABSTRACT

A method for sending a measurement packet and a communication apparatus. The method includes: a first wireless device sends a trigger frame, where the trigger frame is used to trigger a plurality of second wireless devices to send measurement packets in an orthogonal frequency division multiple access (OFDMA) manner; and the first wireless device receives the measurement packets sent by the plurality of second wireless devices in the OFDMA manner. Based on the method, the measurement packet sent by each second wireless device occupies only some tones of an uplink transmission bandwidth. This improves power spectral density of the measurement packet and improves precision of measuring channel information by the first wireless device.

### CROSS-REFERENCE TO RELATED APPLICATIONS

This application is a continuation of International Application No. PCT/CN2022/074281, filed on Jan. 27, 2022, which claims priority to Chinese Patent Application No. 202110178784.7, filed on Feb. 9, 2021. The disclosures of the aforementioned applications are hereby incorporated by reference in their entireties.

### TECHNICAL FIELD

The embodiments relate to the field of communication technologies, a method for sending a measurement packet, and a communication apparatus.

### BACKGROUND

With development of wireless fidelity (Wi-Fi), a 4^{th} generation (4G) mobile communication technology, and a 5^{th} generation (5G) mobile communication technology, various wireless communication devices have been widely deployed in people's daily life. These wireless communication devices include mobile phones, computers, wireless routers, smart home devices, wireless sensors, wireless routers, and the like. These devices are characterized by large quantities, low prices, and very close to users. In a common home environment, more than ten or even hundreds of wireless devices are deployed around a user. Based on channel information in a wireless communication process, these devices may sense a human body action around or measure other information. This technology of sensing the human body action based on the channel information is referred to as a wireless sensing technology. In principle, the wireless sensing technology uses a principle similar to a “human body radar” to sense a human body around.

The wireless sensing technology is used as an example, as shown in FIG. 1, a wireless sensing system includes a first wireless device 101 and a second wireless device 102. In an actual system, there may be one or more first wireless devices and second wireless devices, or the first wireless device and the second wireless device may be disposed in a same physical device. A wireless signal received by the second wireless device 102 includes a direct signal 104 and a reflected signal 105 reflected by a detected target 103. When the detected target 103 moves, the reflected signal 105 changes. As a result, a superimposed wireless signal received by the second wireless device 102 also changes accordingly. In this case, the second wireless device 102 may detect that a channel of a wireless link changes. The channel of the wireless link may be quantized in a communication protocol as channel information, such as channel state information (CSI). The change of a wireless channel is represented by changes of an amplitude and a phase of the channel information. Whether a person moves and an action that is being performed by the person around the second wireless device may be sensed by using the channel information obtained by the second wireless device through measurement as time changes. Therefore, the wireless sensing technology may be widely applied to applications such as intrusion detection, elderly care, gesture recognition, breathing and sleep monitoring, and indoor people counting.

FIG. 2 is a schematic flowchart of an existing method for sending a measurement packet. In FIG. 2, an example in which a first wireless device is an access point (AP), second wireless devices are a station (STA) 1 and a STA 2, and a measurement packet is an NDP frame is used. As shown in FIG. 2, the AP obtains a transmit opportunity TXOP and sends a null data packet announcement (NDPA) frame to the STA 1 and the STA 2, to notify the STA 1 and the STA 2 that channel measurement is to be performed. After the AP sends the NDPA frame, the AP sends the NDP frame to the STA 1 and the STA 2. The STA 1 and the STA 2 measure the NDP frame to obtain channel information. The AP sends a polling frame. If the STA 1 meets a feedback condition, the STA 1 replies with an acknowledgment (ACK) response after receiving the polling frame. If the STA 2 does not meet the feedback condition, the STA 2 does not reply with an ACK response after receiving the polling frame. After receiving the acknowledgment response sent by the STA 1, the AP sends a trigger frame to the STA 1, to trigger the STA 1 to send the NDP frame. After receiving the trigger frame, the STA 1 sends the NDP frame. The AP measures the NDP frame to obtain the channel information. The AP determines a sensing result and a measurement result based on the channel information, or measures other information based on the channel information. The trigger frame indicates a bandwidth on which the NDP frame is sent by the STA 1. The NDP frame sent by the STA 1 to the AP occupies all tones of the bandwidth that is indicated by the trigger frame. Under constraint of total power of the station, power spectral density on each tone is low, and a signal-to-noise ratio at a receive end is low. This affects measurement precision of the channel information.

### SUMMARY

The embodiments may provide a method for sending a measurement packet and a communication apparatus, to help improve measurement precision of channel information.

According to a first aspect, the embodiments may provide a method for sending a measurement packet. The method includes: A first wireless device sends a trigger frame, where the trigger frame is used to trigger a plurality of second wireless devices to send measurement packets in an orthogonal frequency division multiple access (OFDMA) manner; and the first wireless device receives the measurement packets sent by the plurality of second wireless devices in the OFDMA manner.

Based on the method described in the first aspect, the measurement packet sent by each second wireless device occupies only some tones of an uplink transmission bandwidth. This improves power spectral density of the measurement packet and improves precision of measuring the channel information by the first wireless device.

In a possible implementation, the trigger frame includes first indication information. In case 1, the first indication information indicates a group of tones with discontinuous frequencies that is occupied by the measurement packet. The group of tones with discontinuous frequencies that is occupied by the measurement packet can be used to increase a transmission bandwidth of the measurement packet. This is applicable to a scenario in which a high requirement is imposed on the transmission bandwidth of the measurement packet.

In case 2, the first indication information indicates a resource unit (RU) occupied by the measurement packet. The measurement packet may occupy one RU or a plurality of discontinuous RUs. When the measurement packet occupies one RU, tones occupied by the measurement packet are totally continuous. When the first indication information indicates one RU occupied by the measurement packet, the first indication information is applicable to a scenario in which a low requirement is imposed on a transmission bandwidth of the measurement packet. When the measurement packet occupies a plurality of discontinuous RUs, tones occupied by the measurement packet are partially continuous. This is applicable to a scenario in which a high requirement is imposed on a transmission bandwidth of the measurement packet.

In a possible implementation, a manner in which the first indication information indicates the group of tones with discontinuous frequencies that is occupied by the measurement packet. The first indication information indicates an offset value of a non-zero tone and a spacing between adjacent non-zero tones, and the non-zero tone is a tone occupied by the measurement packet. Based on this possible implementation, a group of tones with discontinuous frequencies that is occupied by the measurement packet can be indicated by using only a few bits.

In a possible implementation, the first indication information is located in a user information field in the trigger frame. Based on this possible implementation, a group of tones with discontinuous frequencies that is occupied by the measurement packet can be flexibly indicated to different second wireless devices.

In a possible implementation, the trigger frame further includes second indication information, and the second indication information indicates a type of the measurement packet; and when the first indication information indicates the group of tones with discontinuous frequencies that is occupied by the measurement packet, the type of the measurement packet is the measurement packet that occupies the group of tones with discontinuous frequencies; or when the first indication information indicates the RU occupied by the measurement packet, the type of the measurement packet is the measurement packet that occupies the RU. Based on this possible implementation, the first wireless device can flexibly indicate, to the second wireless device based on an actual requirement, a resource used to send the measurement packet. For example, in a scenario in which a high requirement is imposed on the bandwidth, the first wireless device may indicate, by using the first indication information, a group of tones with discontinuous frequencies that is occupied by the measurement packet; or in a scenario in which a low requirement is imposed on a bandwidth, the first wireless device may indicate, by using the first indication information, the RU occupied by the measurement packet.

In a possible implementation, the trigger frame includes a common information field, and the second indication information is located in the common information field. For example, the common information field includes a trigger dependent common information subfield, and the second indication information may be located in the trigger dependent common information subfield. Alternatively, the second indication information may be located in another subfield of the common information field. The second indication information is located in the common information field. This can avoid carrying the second indication information in each user information field.

In a possible implementation, the trigger frame further includes third indication information, and the third indication information indicates that a type of the trigger frame is a wireless sensing type. Based on this possible implementation, in a wireless sensing scenario, the measurement packet sent by each second wireless device occupies only some tones of an uplink transmission bandwidth. This may improve power spectral density of the measurement packet, precision of measuring the channel information by the first wireless device, and measurement precision of a wireless sensing result.

Optionally, the third indication information is located in a trigger type subfield of the common information field.

According to a second aspect, the embodiments may provide a method for sending a measurement packet. The method includes: A second wireless device receives a trigger frame sent by a first wireless device, where the trigger frame is used to trigger the second wireless device to send a measurement packet in an OFDMA manner; and the second wireless device sends the measurement packet to the first wireless device in the OFDMA manner.

In a possible implementation, the trigger frame includes first indication information, and the first indication information indicates a group of tones with discontinuous frequencies that is occupied by the measurement packet; or the first indication information indicates a resource unit RU occupied by the measurement packet.

In a possible implementation, a manner in which the first indication information indicates the group of tones with discontinuous frequencies that is occupied by the measurement packet. The first indication information indicates an offset value of a non-zero tone and a spacing between adjacent non-zero tones, and the non-zero tone is a tone occupied by the measurement packet.

In a possible implementation, the first indication information is located in a user information field in the trigger frame.

In a possible implementation, the trigger frame further includes second indication information, and the second indication information indicates a type of the measurement packet; and when the first indication information indicates the group of tones with discontinuous frequencies that is occupied by the measurement packet, the type of the measurement packet is the measurement packet that occupies the group of tones with discontinuous frequencies; or when the first indication information indicates the RU occupied by the measurement packet, the type of the measurement packet is the measurement packet that occupies the RU.

In a possible implementation, the trigger frame includes a common information field, and the second indication information is located in the common information field.

In a possible implementation, the trigger frame further includes third indication information, and the third indication information indicates that a type of the trigger frame is a wireless sensing type.

For beneficial effect that is not mentioned in the second aspect, refer to the beneficial effect of the first aspect. Details are not described herein.

According to a third aspect, the embodiments may provide a communication apparatus. The communication apparatus includes: a communication unit, configured to send a trigger frame, where the trigger frame is used to trigger a plurality of second wireless devices to send measurement packets in an OFDMA manner; and the communication unit is further configured to receive the measurement packets sent by the plurality of second wireless devices in the OFDMA manner.

In a possible implementation, the trigger frame includes first indication information, and the first indication information indicates a group of tones with discontinuous frequencies that is occupied by the measurement packet; or the first indication information indicates a resource unit RU occupied by the measurement packet.

In a possible implementation, a manner in which the first indication information indicates the group of tones with discontinuous frequencies that is occupied by the measurement packet. The first indication information indicates an offset value of a non-zero tone and a spacing between adjacent non-zero tones, and the non-zero tone is a tone occupied by the measurement packet.

In a possible implementation, the first indication information is located in a user information field in the trigger frame.

In a possible implementation, the trigger frame further includes second indication information, and the second indication information indicates a type of the measurement packet; and when the first indication information indicates the group of tones with discontinuous frequencies that is occupied by the measurement packet, the type of the measurement packet is the measurement packet that occupies the group of tones with discontinuous frequencies; or when the first indication information indicates the RU occupied by the measurement packet, the type of the measurement packet is the measurement packet that occupies the RU.

In a possible implementation, the trigger frame includes a common information field, and the second indication information is located in the common information field.

In a possible implementation, the trigger frame further includes third indication information, and the third indication information indicates that a type of the trigger frame is a wireless sensing type.

According to a fourth aspect, the embodiments may provide a communication apparatus. The communication apparatus includes: a communication unit, configured to receive a trigger frame sent by a first wireless device, where the trigger frame is used to trigger a second wireless device to send a measurement packet in an OFDMA manner; and the communication unit is further configured to send the measurement packet to the first wireless device in the OFDMA manner.

In a possible implementation, the trigger frame includes first indication information, and the first indication information indicates a group of tones with discontinuous frequencies that is occupied by the measurement packet; or the first indication information indicates a resource unit RU occupied by the measurement packet.

In a possible implementation, a manner in which the first indication information indicates the group of tones with discontinuous frequencies that is occupied by the measurement packet. The first indication information indicates an offset value of a non-zero tone and a spacing between adjacent non-zero tones, and the non-zero tone is a tone occupied by the measurement packet.

In a possible implementation, the first indication information is located in a user information field in the trigger frame.

In a possible implementation, the trigger frame further includes second indication information, and the second indication information indicates a type of the measurement packet; and when the first indication information indicates the group of tones with discontinuous frequencies that is occupied by the measurement packet, the type of the measurement packet is the measurement packet that occupies the group of tones with discontinuous frequencies; or when the first indication information indicates the RU occupied by the measurement packet, the type of the measurement packet is the measurement packet that occupies the RU.

In a possible implementation, the trigger frame includes a common information field, and the second indication information is located in the common information field.

In a possible implementation, the trigger frame further includes third indication information, and the third indication information indicates that a type of the trigger frame is a wireless sensing type.

According to a fifth aspect, the embodiments may provide a communication apparatus. The communication apparatus includes a processor, and when the processor invokes a computer program in a memory, the method according to the first aspect or the second aspect is performed.

According to a sixth aspect, the embodiments may provide a communication apparatus, including a processor and a communication interface. The communication interface is configured to communicate with another communication apparatus. The processor is configured to run a program, so that the communication apparatus implements the method according to the first aspect or the second aspect.

According to a seventh aspect, the embodiments may provide a communication apparatus. The communication apparatus includes a processor and a memory, the memory is configured to store computer-executable instructions, and the processor is configured to execute the computer-executable instructions stored in the memory, so that the communication apparatus performs the method according to the first aspect or the second aspect.

According to an eighth aspect, the embodiments may provide a communication apparatus. The communication apparatus includes a processor, a memory, and a transceiver. The transceiver is configured to receive a signal or send a signal. The memory is configured to store program code. The processor is configured to invoke the program code from the memory to perform the method according to the first aspect or the second aspect.

According to a ninth aspect, the embodiments may provide a communication apparatus. The communication apparatus includes a processor and an interface circuit. The interface circuit is configured to receive code instructions and transmit the code instructions to the processor. The processor runs the code instructions to perform the method according to the first aspect or the second aspect.

According to a tenth aspect, an embodiment may provide a system. The system includes the communication apparatus according to the third aspect or the fourth aspect.

According to an eleventh aspect, the embodiments may provide a non-transitory computer-readable storage medium. The non-transitory computer-readable storage medium is configured to store instructions. When the instructions are executed, the method according to the first aspect or the second aspect is implemented.

According to a twelfth aspect, an embodiment may provide a computer program or a computer program product, including code or instructions. When the code is run or the instructions are run on a computer, the computer is enabled to perform the method according to the first aspect or the second aspect.

### BRIEF DESCRIPTION OF THE DRAWINGS

FIG. 1 is a schematic diagram of an existing wireless sensing system;

FIG. 2 is a schematic flowchart of an existing method for sending a measurement packet;

FIG. 3 is a schematic diagram of a system architecture according to an embodiment;

FIG. 4 is a schematic diagram of an application scenario according to an embodiment;

FIG. 5 is a schematic diagram of another application scenario according to an embodiment;

FIG. 6 is a schematic flowchart of a method for sending a measurement packet according to an embodiment;

FIG. 7 is a schematic diagram of a tone distribution and an RU distribution on a 20 MHz bandwidth according to an embodiment;

FIG. 8 is a schematic diagram of a tone distribution and an RU distribution on a 40 MHz bandwidth according to an embodiment;

FIG. 9 is a schematic diagram of a tone distribution and an RU distribution on an 80 MHz bandwidth according to an embodiment;

FIG. 10 is a schematic diagram of a structure of a trigger frame according to an embodiment;

FIG. 11 is a schematic diagram of a structure of a user information field 1 according to an embodiment;

FIG. 12 is a schematic diagram of a structure of another user information field 1 according to an embodiment;

FIG. 13 is a schematic diagram of a structure of a common information field according to an embodiment;

FIG. 14 is a schematic diagram of a structure of a communication apparatus according to an embodiment; and

FIG. 15 is a schematic diagram of a structure of another communication apparatus according to an embodiment.

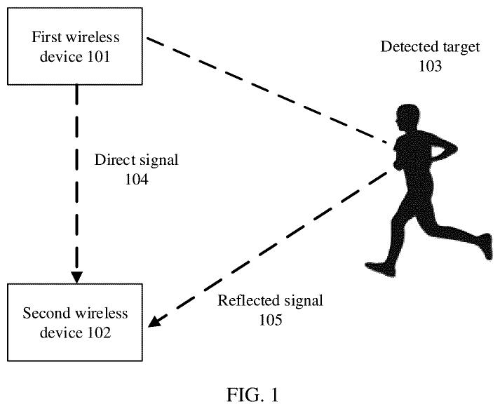

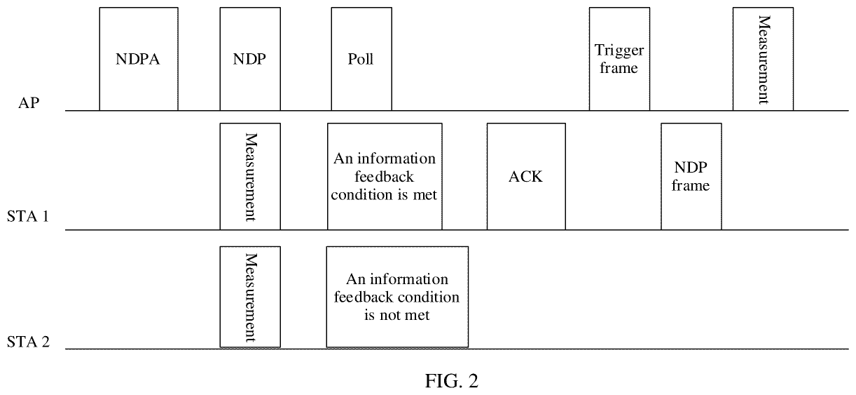

### DETAILED DESCRIPTION OF THE EMBODIMENTS

The following further describes the embodiments in detail with reference to the accompanying drawings.

The embodiments may provide a method for sending a measurement packet and a communication apparatus. The method provided in the embodiments may be applied to a wireless fidelity (Wi-Fi) system. The method may also be extended to a wireless cellular network, for example, an LTE or 5G system. The method may be implemented by a communication device or a chip or a processor in the communication device. In the Wi-Fi system, the communication device supports the 802.11be standard or a standard after the 802.11be standard.

To better understand the embodiments, the following first describes a system architecture.

The system architecture may include one or more first wireless devices and one or more second wireless devices. The first wireless device may be an access point (AP) station, and the second wireless device may be a non-access point station (non-AP STA). For ease of description, an access point station is referred to as an access point (AP), and a non-access point station is referred to as a station (STA). Alternatively, the first wireless device is an access point, and the second wireless device is also an access point. Alternatively, the first wireless device is a station, and the second wireless device is also a station. Alternatively, the first wireless device is a station, and the second wireless device is an access point. The first wireless device is configured to trigger the second wireless device to send a measurement packet, so that the first wireless device receives the measurement packet and obtains channel information, and the first wireless device can determine a wireless sensing result or determine other information based on the channel information.

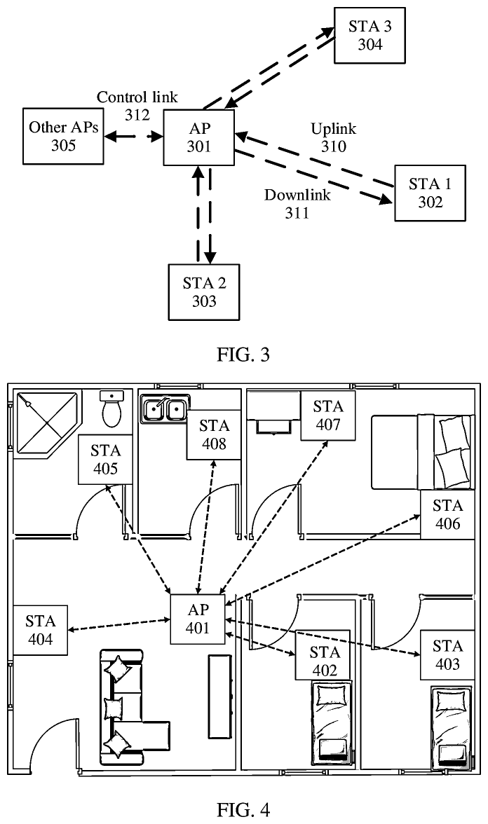

For example, the first wireless device is an access point, and the second wireless device is a station. FIG. 3 is a schematic diagram of a system architecture according to an embodiment.

An access point may be an access point used by a terminal device (such as a mobile phone) to access a wired (or wireless) network and may be deployed at home, in a building, and in a park. A typical coverage radius is tens of meters to hundreds of meters. The access point may also be deployed outdoors. The access point is equivalent to a bridge that connects a wired network and a wireless network. A main function of the access point is to connect various wireless network clients together and then connect the wireless network to the Ethernet. The access point may be a terminal device (such as a mobile phone) or a network device (such as a router) with a Wi-Fi chip. The access point may be a device that supports the 802.11be standard or a standard after the 802.11be standard.

A station may be a wireless communication chip, a wireless sensor, a wireless communication terminal, or the like. For example, the station may be a mobile phone, a tablet computer, a set-top box, a smart television set, a smart wearable device, a vehicle-mounted communication device, a computer, or the like that supports a Wi-Fi communication function.

The access point and the station interact with each other through a wireless network protocol, for example, a Wi-Fi protocol. A link on which a station performs sending and an access point performs receiving is referred to as an uplink, for example, an uplink 310 in FIG. 3. A link on which an access point performs sending and a station performs receiving is referred to as a downlink, for example, a downlink 311 in FIG. 3. The access point may interact with another access point on a control link 312. The control link 312 may be connected in a wired Ethernet manner or a wireless network manner and may be used to coordinate different access points and perform monitoring.

The method for sending the measurement packet provided in the embodiments may be used to perform wireless sensing or measure other information. A technology that uses channel information to sense human body actions is referred to as a wireless sensing technology. Wireless sensing may also be referred to as wireless passive sensing. An application scenario of the method for sending the measurement packet provided in the embodiments may include a plurality of scenarios. For example, two typical scenarios are an application scenario in a home environment and an application scenario in an industrial and commercial environment. The application scenario in the home environment is shown in FIG. 4. For example, the method for sending the measurement packet provided in the embodiments is used for wireless sensing, the first wireless device is an AP, and the second wireless device is a STA. When the method is applied in the home environment, an AP 401 may be deployed. The node may perform measurement interaction with a plurality of STAs 402-408 in the figure to monitor the entire home environment. For example, a link between the AP 401 and a STA 405 may be used to measure an action status in a bathroom. If a slip action is monitored, the AP may send an alarm in time to notify medical personnel. A link between the AP 401 and a STA 404 may be used to measure an action status in a living room. If a gesture is detected, the AP may control a light switch, a television channel switching, and the like. In addition, the AP 401 and a STA 402, a STA 403, and a STA 406 in bedrooms may also monitor a sleep status of the user.

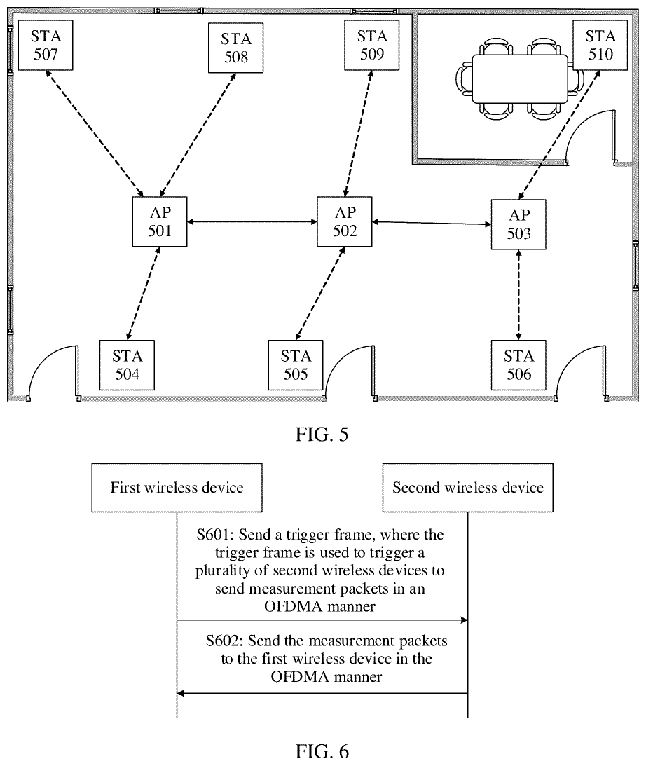

FIG. 5 shows an application scenario in the industrial and commercial environment. For example, the method for sending the measurement packet provided in the embodiments may be used for wireless sensing, the first wireless device is an AP, and the second wireless device is a STA. In an office scenario, a to-be-monitored area has a large range, and a plurality of APs may be used. As shown in the figure, 501, 502, and 503 are all APs. Each AP interacts with one or more STAs to complete measurement in an area. For example, a link between the AP 501 and a STA 504 may be used to monitor an entry and exit condition at a door. A link between the AP 503 and a STA 510 may be used to monitor an occupation status and count conference participants in a conference room.

The following further describes the method for sending the measurement packet and the communication apparatus.

FIG. 6 is a schematic flowchart of a method for sending a measurement packet according to an embodiment. As shown in FIG. 6, the method for sending the measurement packet includes the following step 601 and step 602. The method shown in FIG. 6 may be performed by a first wireless device and a second wireless device. Alternatively, the method shown in FIG. 6 may be performed by a chip in the first wireless device and a chip in the second wireless device. FIG. 6 is described by using an example in which the first wireless device and the second wireless device are execution bodies.

601: The first wireless device sends a trigger frame, where the trigger frame is used to trigger a plurality of second wireless devices to send measurement packets in an OFDMA manner.

602: The second wireless device sends the measurement packet to the first wireless device in the OFDMA manner.

In this embodiment, after receiving the trigger frame sent by the first wireless device, the second wireless device sends the measurement packet to the first wireless device in the OFDMA manner. Correspondingly, the first wireless device can receive the measurement packet sent by the second wireless device in the OFDMA manner, to obtain channel information. Further, the first wireless device may determine a wireless sensing result or other information based on the channel information. The channel information may be channel state information (CSI). Alternatively, the channel information may be a part of the CSI.

The measurement packet may be a null data packet (NDP) or may be a sounding physical layer protocol data unit (PPDU), or another data packet including a training symbol.

Orthogonal frequency division multiple access (OFDMA) means that a transmission bandwidth is divided into a series of orthogonal tone sets that do not overlap each other, and different tone sets are allocated to different users to implement multiple access. Because different users occupy tone sets that do not overlap each other, in an ideal synchronization case, no interference between a plurality of users occurs in a system. The OFDMA can be assumed to be a manner of dividing all the resources (time and bandwidths) over frequencies to implement multi-user access. In other words, the measurement packet sent by each second wireless device occupies only some carriers of the transmission bandwidth, and measurement packets sent by different second wireless devices occupy different tones.

For example, it is assumed that the first wireless device is an AP, the second wireless device includes a STA 1 and a STA 2, and an uplink transmission bandwidth is 20 MHz. 20 MHz includes 256 tones. The AP sends the trigger frame, where the trigger frame is used to trigger the STA 1 and the STA 2 to send a measurement packet in the OFDMA manner. After receiving the trigger frame, the STA 1 sends the measurement packet to the first wireless device, where the measurement packet occupies some of the 256 tones. After receiving the trigger frame, the STA 2 sends the measurement packet to the first wireless device, where the measurement packet occupies some of the 256 tones. The tones occupied by the measurement packet sent by the STA 1 are different from the tones occupied by the measurement packet sent by the STA 2.

Based on the method described in FIG. 6, the measurement packet sent by each second wireless device occupies only some tones of the uplink transmission bandwidth. This improves power spectral density of the measurement packet and improves precision of measuring the channel information by the first wireless device.

In a possible implementation, the tones occupied by the measurement packet may be all continuous, or may be partially continuous, or may be totally discontinuous.

In a possible implementation, the trigger frame includes first indication information, and content indicated by the first indication information has the following two cases:
1. The first indication information indicates a group of tones with discontinuous frequencies that is occupied by the measurement packet.

In other words, the tones occupied by the measurement packet are totally discontinuous. The tone occupied by the measurement packet is sampled at an interval of the entire uplink transmission bandwidth. This helps increase the transmission bandwidth of the measurement packet and is applicable to a scenario in which a high requirement is imposed on the transmission bandwidth of the measurement packet.

In a possible implementation, a manner in which the first indication information indicates the group of tones with discontinuous frequencies that is occupied by the measurement packet. The first indication information indicates an offset value of a non-zero tone and a spacing between adjacent non-zero tones, and the non-zero tone is a tone occupied by the measurement packet. Based on this possible implementation, a group of tones with discontinuous frequencies that is occupied by the measurement packet can be indicated by using only a few bits.

The offset value of the non-zero tone is an offset value of a tone index number between the non-zero tone and a tone that is not occupied by the measurement packet. Optionally, the offset value of the non-zero tone may be a value in 0-15. A spacing between adjacent non-zero tones is greater than or equal to 1.

For example, as shown in the following Table 1, T_{offset} indicates an offset value of a non-zero tone. Ng indicates a spacing between adjacent non-zero tones. When an uplink transmission bandwidth is 20 MHz, a group of tones with discontinuous frequencies that is occupied by the measurement packet may be represented as [−((4+T_{offset}):Ng:122), (4+T_{offset}):Ng:122]. −((4+T_{offset}):Ng:122) indicates that, in a tone index number range from −(4+T_{offset}) to −122, starting from a tone corresponding to a tone index number −(4+T_{offset}), there is one non-zero tone at an interval of Ng tones. A tone corresponding to the tone index number −122 may be a non-zero tone or may not be a non-zero tone. For example, it is assumed that T_{offset} is 2, and Ng is 3, the non-zero tones include a tone corresponding to a tone index number −6, a tone corresponding to a tone index number −9, a tone corresponding to a tone index number −12, . . . , and the like. In a tone index number range from −6 to −122, there is one non-zero tone at an interval of three tones. (4+T_{offset}):Ng:122 indicates that in a tone index number range (4+T_{offset}) to 122, starting from a tone corresponding to a tone index number (4+T_{offset}) , there is one non-zero tone at an interval of Ng tones. A tone corresponding to the tone index number 122 may be a non-zero tone or may not be a non-zero tone. For example, it is assumed that T_{offset} is 2, and Ng is 3, the non-zero tones include a tone corresponding to a tone index number 6, a tone corresponding to a tone index number 9, a tone corresponding to a tone index number 12, . . . , and the like. In a tone index number range from 6 to 122, there is one non-zero tone at an interval of three tones. In the following Table 1, when an uplink transmission bandwidth is 40 MHz, 80 MHz, 160 MHz, or 320 MHz, principles of indicating, by using the offset value of the non-zero tone and the spacing between adjacent non-zero tones, a group of tones with discontinuous frequencies that is occupied by the measurement packet are the same. Details are not described herein.

TABLE 1

| BW | 20 MHZ | 40 MHZ | 80 MHz | 160 MHZ | 320 MHZ |
|---|---|---|---|---|---|
| 1 | [−((4 + | −[(4 + | −[(260 + | −[(772 + | −[(1796 + |
| | T_{offset}):Ng:122), | T_{offset}):Ng:244] | T_{offset}):Ng:500] | T_{offset}):Ng:1012] | T_{offset}):Ng:2036] |
| | (4 + | | | | |
| | T_{offset}):Ng:122]; | | | | |
| 2 | | [(4 + | −[(12 + | −[(524 + | −[(1548 + |
| | | T_{offset}):Ng:244] | T_{offset}):Ng:252] | T_{offset}):Ng:764] | T_{offset}):Ng:1788] |
| 3 | | | [(12 + | −[(260 + | −[(1284 + |
| | | | T_{offset}):Ng:252] | T_{offset}):Ng:500] | T_{offset}):Ng:1524] |
| 4 | | | [(260 + | −[(12 + | −[(1036 + |
| | | | T_{offset}):Ng:500] | T_{offset}):Ng:252] | T_{offset}):Ng:1276] |
| 5 | | | | [(12 + | −[(772 + |
| | | | | T_{offset}):Ng:252] | T_{offset}):Ng:1012] |
| 6 | | | | [(260 + | −[(524 + |
| | | | | T_{offset}):Ng:500] | T_{offset}):Ng:764] |
| 7 | | | | [(524 + | −[(260 + |
| | | | | T_{offset}):Ng:764] | T_{offset}):Ng:500] |
| 8 | | | | [(772 + | −[(12 + |
| | | | | T_{offset}):Ng:1012] | T_{offset}):Ng:252] |
| 9 | | | | | [(12 + |
| | | | | | T_{offset}):Ng:252] |
| 10 | | | | | [(260 + |
| | | | | | T_{offset}):Ng:500)] |
| 11 | | | | | [(524 + |
| | | | | | T_{offset}):Ng:764] |
| 12 | | | | | [(772 + |
| | | | | | T_{offset}):Ng:1012)] |
| 13 | | | | | [(1036 + |
| | | | | | T_{offset}):Ng:1276] |
| 14 | | | | | [(1284 + |
| | | | | | T_{offset}):Ng:1524] |
| 15 | | | | | [(1548 + |
| | | | | | T_{offset}):Ng:1788] |
| 16 | | | | | [(1796 + |
| | | | | | T_{offset}):Ng:2036] |

2. The first indication information indicates a resource unit (resource unit, RU) occupied by the measurement packet.

The RU may be in a form of a 26-tone RU, 52-tone RU, 106-tone RU, 242-tone RU, a 484-tone RU, a 996-tone RU, or the like, where tone indicates a tone.

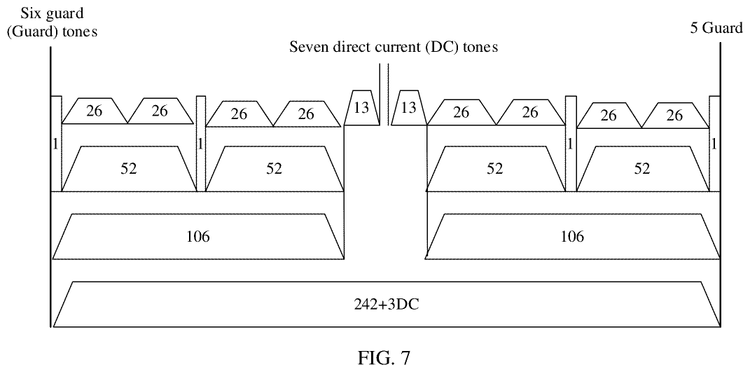

For example, FIG. 7 is a schematic diagram of a tone distribution and an RU distribution on a 20 MHz bandwidth according to this embodiment. As shown in FIG. 7, when the bandwidth is 20 MHz, the entire bandwidth may include an entire 242-tone RU or various combinations of a 26-tone RU, a 52-tone RU, and a 106-tone RU. In addition to the RU used to transmit data, the bandwidth further includes some guard tones, null tones (a tone in which 1 is located in the figure is a null tone, and 1 indicates that a quantity of null tones is 1), or direct current (DC) tones.

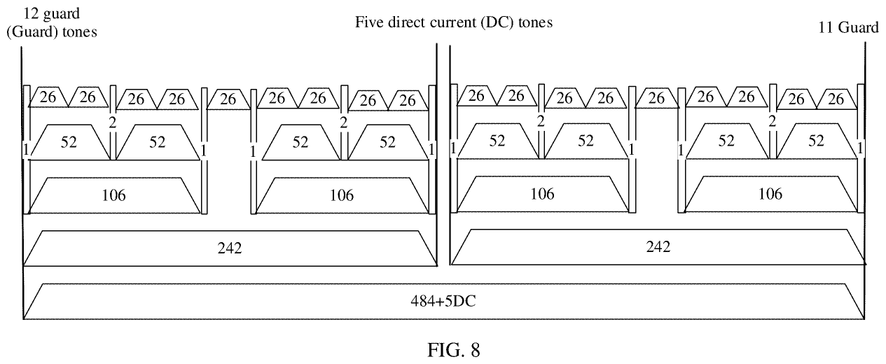

For another example, FIG. 8 is a schematic diagram of a tone distribution and an RU distribution of a 40 MHz bandwidth according to this embodiment. As shown in FIG. 8, when the bandwidth is 40 MHz, the entire bandwidth may be approximately equivalent to replication of a tone distribution on a 20 MHz bandwidth and may include an entire 484-tone RU or various combinations of a 26-tone RU, a 52-tone RU, a 106-tone RU, and a 242-tone RU.

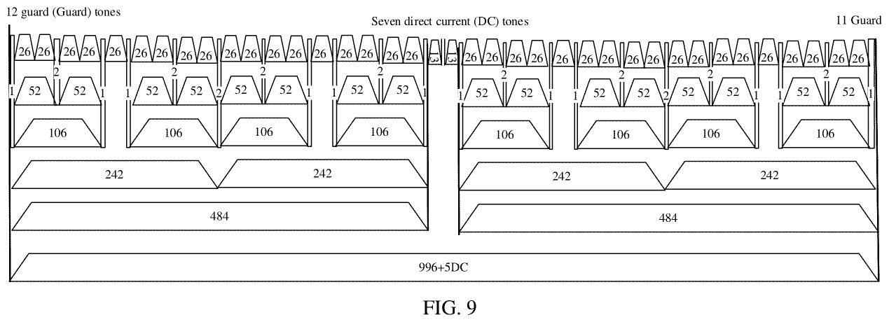

For still another example, FIG. 9 is a schematic diagram of a tone distribution and an RU distribution on an 80 MHz bandwidth according to this embodiment. As shown in FIG. 9, when the bandwidth is 80 MHz, the entire bandwidth includes four 242-tone RUs. In the middle of the entire bandwidth, there may be an intermediate 26-tone RU including two 13-tone subunits. The entire bandwidth may include an entire 996-tone RU or may include various combinations of a 26-tone RU, a 52-tone RU, a 106-tone RU, a 242-tone RU, and a 484-tone RU.

When a bandwidth is 160 MHz or 80+80 MHz, the entire bandwidth may be considered as replication of tone distributions of two 80 MHz bandwidths. The entire bandwidth may include an entire 2*996-tone RU or may include various combinations of a 26-tone RU, a 52-tone RU, a 106-tone RU, a 242-tone RU, a 484-tone RU, and a 996-tone RU.

In a possible implementation, the measurement packet may occupy one RU or a plurality of discontinuous RUs. When the measurement packet occupies one RU, tones occupied by the measurement packet are totally continuous. When the first indication information indicates one RU occupied by the measurement packet, the first indication information is applicable to a scenario in which a low requirement is imposed on a transmission bandwidth of the measurement packet. When the measurement packet occupies a plurality of discontinuous RUs, tones occupied by the measurement packet are partially continuous. This is applicable to a scenario in which a high requirement is imposed on a transmission bandwidth of the measurement packet.

In a possible implementation, the first indication information indicates, by indicating a location and a size of an RU occupied by the measurement packet, the RU occupied by the measurement packet.

In a possible implementation, the first indication information is located in a user information (user info) field in the trigger frame. Based on this possible implementation, a group of tones with discontinuous frequencies that is occupied by the measurement packet can be flexibly indicated to different second wireless devices.

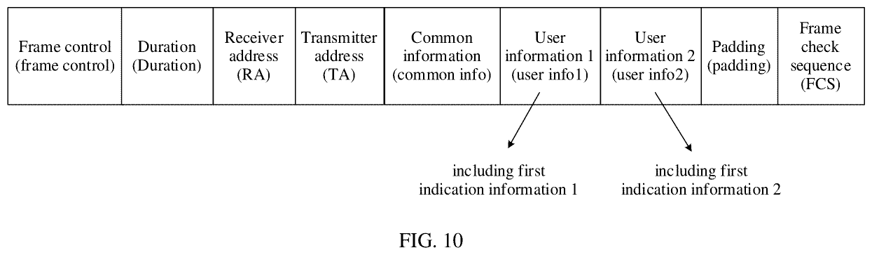

For example, FIG. 10 is a schematic diagram of a structure of the trigger frame. As shown in FIG. 10, the trigger frame includes first indication information 1 and first indication information 2, the first indication information 1 is located in a user information field 1, and the first indication information 2 is located in an information field 2. The user information field 1 corresponds to the STA 1, and the user information field 2 corresponds to the STA 2. The first indication information 1 indicates a group of tones with discontinuous frequencies that is occupied by the measurement packet sent by the STA 1, or the first indication information 1 indicates an RU occupied by the measurement packet sent by the STA 1. The first indication information 2 indicates a group of tones with discontinuous frequencies that is occupied by the measurement packet sent by the STA 2, or the first indication information 2 indicates an RU occupied by the measurement packet sent by the STA 2.

FIG. 11 is a schematic diagram of a structure of a user information field 1. As shown in FIG. 11, the user information field 1 includes an association identifier (AID12) subfield, a number of grouping (Ng) subfield, and a tone offset subfield. The AID 12 subfield indicates an identifier of the STA 1. The Ng subfield indicates a spacing between adjacent non-zero tones. The tone offset subfield indicates an offset value of a non-zero tone. The user information field 1 may further include another subfield that is not shown because it is irrelevant to this solution. A structure of the user information field 2 is similar, and details are not described herein again.

FIG. 12 is a schematic diagram of a structure of another user information field 1. As shown in FIG. 12, the user information field 1 includes an association identifier (AID12) subfield and an RU allocation subfield. The AID 12 subfield indicates an identifier of the STA 1. The RU allocation subfield indicates a resource unit occupied by the measurement packet. The user information field 1 may further include another subfield that is not shown because it is irrelevant to this solution. A structure of the user information field 2 is similar, and details are not described herein again.

In a possible implementation, the trigger frame further includes second indication information, and the second indication information indicates a type of the measurement packet; and when the first indication information indicates the group of tones with discontinuous frequencies that is occupied by the measurement packet, the type of the measurement packet is the measurement packet that occupies the group of tones with discontinuous frequencies; or when the first indication information indicates the RU occupied by the measurement packet, the type of the measurement packet is the measurement packet that occupies the RU. Based on this possible implementation, the first wireless device can flexibly indicate, to the second wireless device based on an actual requirement, a resource used to send the measurement packet. For example, in a scenario in which a high requirement is imposed on the bandwidth, the first wireless device may indicate, by using the first indication information, a group of tones with discontinuous frequencies that is occupied by the measurement packet; or in a scenario in which a low requirement is imposed on a bandwidth, the first wireless device may indicate, by using the first indication information, the RU occupied by the measurement packet.

Alternatively, the trigger frame may not include the second indication information. A protocol may specify that the first indication information indicates a group of tones with discontinuous frequencies that is occupied by the measurement packet, or a protocol may specify that the first indication information indicates an RU occupied by the measurement packet.

In a possible implementation, the trigger frame includes a common information field, and the second indication information is located in the common information field. For example, the common information field includes a trigger dependent common information subfield, and the second indication information may be located in the trigger dependent common information subfield. Alternatively, the second indication information may be located in another subfield of the common information field. The second indication information is located in the common information field. This can avoid carrying the second indication information in each user information field.

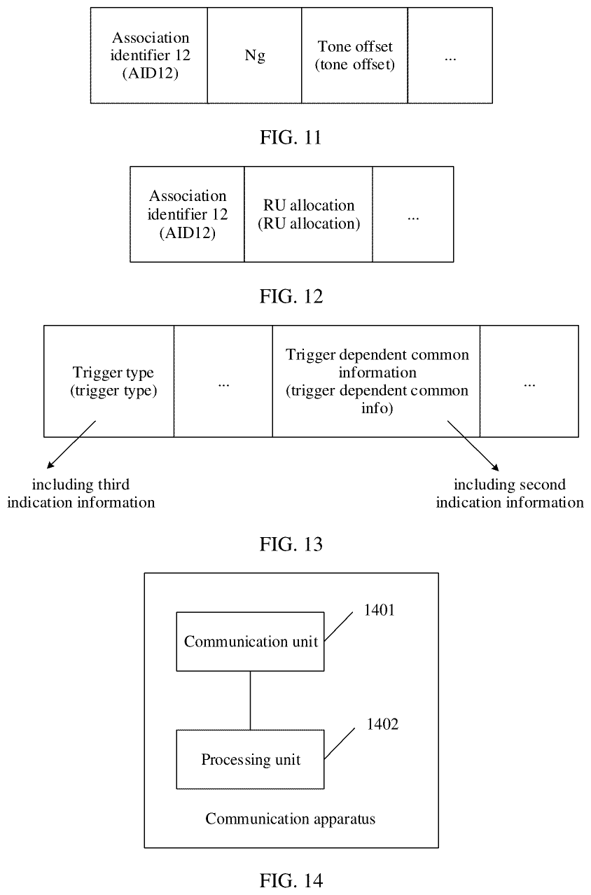

For example, FIG. 13 is a schematic diagram of a structure of a common information field. As shown in FIG. 13, the common information field includes a trigger type subfield and a trigger dependent common information subfield. The common information field may further include another subfield that is not shown because it is irrelevant to this solution. As shown in FIG. 13, the second indication information is located in the trigger dependent common information subfield.

In a possible implementation, the trigger frame further includes third indication information, and the third indication information indicates that a type of the trigger frame is a wireless sensing type. Based on this possible implementation, in a wireless sensing scenario, the measurement packet sent by each second wireless device occupies only some tones of an uplink transmission bandwidth. This improves power spectral density of the measurement packet and improves precision of measuring the channel information by the first wireless device and improves measurement precision of a wireless sensing result.

Optionally, the third indication information is located in a trigger type subfield of a common information field of the trigger frame. For example, as shown in FIG. 13, a new type, such as a wireless sensing type, may be added to the trigger type subfield of the trigger frame to indicate a wireless sensing type. When the trigger type subfield indicates the wireless sensing type, a value of the trigger type subfield may be any one of 8-15. For example, a value of the trigger frame type subfield and a corresponding trigger frame type may be shown in Table 2.

TABLE 2

| Value of a | |
|---|---|
| trigger type field | Trigger frame type |
| 0 | Basic |
| 1 | Beamforming report poll (BFRP) |
| 2 | Multi-user block acknowledgment request (MU-BAR) |
| 3 | Multi-user request to send (MU-RTS) |
| 4 | Buffer status report poll (BSRP) |
| 5 | Group cast with retries multi-user block |
| | acknowledgment request (GCR MU-BAR) |
| 6 | Bandwidth query report poll (BQRP) |
| 7 | Null data frame feedback report poll (NDP NFRP) |
| 8 | Wireless sensing (sensing sounding) |
| 9-15 | Reserve |

FIG. 14 is a schematic diagram of a structure of a communication apparatus according to an embodiment. The communication apparatus shown in FIG. 14 may be configured to perform some or all functions of the first wireless device in the method embodiment described in FIG. 6. The apparatus may be the first wireless device, an apparatus in the first wireless device, or an apparatus that can be used together with the first wireless device. The communication apparatus may alternatively be a chip system. The communication apparatus shown in FIG. 14 may include a communication unit 1401 and a processing unit 1402. The processing unit 1402 is configured to perform data processing. A receiving unit and a sending unit are integrated into the communication unit 1401. The communication unit 1401 may also be referred to as a transceiver unit. Alternatively, the communication unit 1401 may be split into a receiving unit and a sending unit. The processing unit 1402 and the communication unit 1401 below are similar, and details are not described below again.

The communication unit 1401 is configured to send a trigger frame, where the trigger frame is used to trigger a plurality of second wireless devices to send measurement packets in an OFDMA manner. The processing unit 1402 is further configured to receive the measurement packets sent by the plurality of second wireless devices in the OFDMA manner.

In a possible implementation, the trigger frame includes first indication information, and the first indication information indicates a group of tones with discontinuous frequencies that is occupied by the measurement packet; or the first indication information indicates a resource unit RU occupied by the measurement packet.

In a possible implementation, a manner in which the first indication information indicates the group of tones with discontinuous frequencies that is occupied by the measurement packet is: the first indication information indicates an offset value of a non-zero tone and a spacing between adjacent non-zero tones, and the non-zero tone is a tone occupied by the measurement packet.

In a possible implementation, the first indication information is located in a user information field in the trigger frame.

In a possible implementation, the trigger frame further includes second indication information, and the second indication information indicates a type of the measurement packet; and when the first indication information indicates the group of tones with discontinuous frequencies that is occupied by the measurement packet, the type of the measurement packet is the measurement packet that occupies the group of tones with discontinuous frequencies; or when the first indication information indicates the RU occupied by the measurement packet, the type of the measurement packet is the measurement packet that occupies the RU.

In a possible implementation, the trigger frame includes a common information field, and the second indication information is located in the common information field.

In a possible implementation, the trigger frame further includes third indication information, and the third indication information indicates that a type of the trigger frame is a wireless sensing type.

FIG. 14 is a schematic diagram of a structure of a communication apparatus according to an embodiment. The communication apparatus shown in FIG. 14 may be configured to perform some or all functions of the second wireless device in the method embodiment described in FIG. 6. The apparatus may be a second wireless device, an apparatus in a second wireless device, or an apparatus that can be used together with the second wireless device. The communication apparatus may alternatively be a chip system. The communication apparatus shown in FIG. 14 may include a communication unit 1401 and a processing unit 1402.

The communication unit 1401 is configured to receive a trigger frame sent by a first wireless device, where the trigger frame is used to trigger a second wireless device to send a measurement packet in an OFDMA manner. The processing unit 1402 is further configured to send the measurement packet to the first wireless device in the OFDMA manner.

In a possible implementation, the trigger frame includes first indication information, and the first indication information indicates a group of tones with discontinuous frequencies that is occupied by the measurement packet; or the first indication information indicates a resource unit RU occupied by the measurement packet.

In a possible implementation, a manner in which the first indication information indicates the group of tones with discontinuous frequencies that is occupied by the measurement packet is: the first indication information indicates an offset value of a non-zero tone and a spacing between adjacent non-zero tones, and the non-zero tone is a tone occupied by the measurement packet.

In a possible implementation, the first indication information is located in a user information field in the trigger frame.

In a possible implementation, the trigger frame further includes second indication information, and the second indication information indicates a type of the measurement packet; and when the first indication information indicates the group of tones with discontinuous frequencies that is occupied by the measurement packet, the type of the measurement packet is the measurement packet that occupies the group of tones with discontinuous frequencies; or when the first indication information indicates the RU occupied by the measurement packet, the type of the measurement packet is the measurement packet that occupies the RU.

In a possible implementation, the trigger frame includes a common information field, and the second indication information is located in the common information field.

In a possible implementation, the trigger frame further includes third indication information, and the third indication information indicates that a type of the trigger frame is a wireless sensing type.

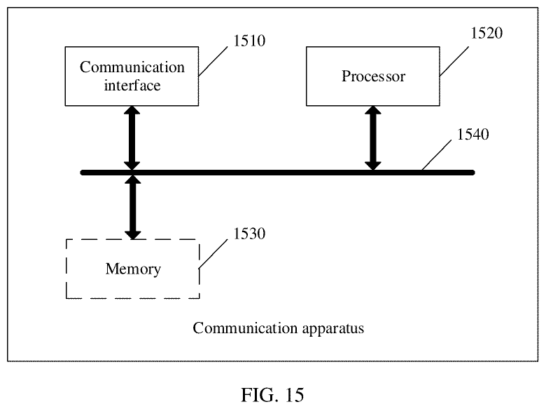

FIG. 15 shows a communication apparatus 150 according to an embodiment. The communication apparatus 150 is configured to implement functions of the first wireless device in FIG. 6. The apparatus may be a first wireless device or may be an apparatus used in a first wireless device. The apparatus used in the first wireless device may be a chip system or a chip in the first wireless device. The chip system may include a chip or may include a chip and another discrete component.

Alternatively, the communication apparatus 150 is configured to implement functions of the second wireless device in FIG. 6. The apparatus may be a second wireless device or may be an apparatus used in a second wireless device. The apparatus used in the second wireless device may be a chip system or a chip in the second wireless device.

The communication apparatus 150 includes at least one processor 1520, configured to implement a data processing function of the first wireless device or the second wireless device in the methods provided in the embodiments. The communication apparatus 150 may further include a communication interface 1510, configured to implement receiving and sending operations of the first wireless device or the second wireless device in the method provided in the embodiments. In this embodiment, the communication interface may be a transceiver, a circuit, a bus, a module, or another type of communication interface, and is configured to communicate with another device through a transmission medium. For example, the communication interface 1510 is used by an apparatus in the communication apparatus 150 to communicate with another device. The processor 1520 receives and sends data by using the communication interface 1510 and is configured to implement the method in the foregoing method embodiments in FIG. 6.

The communication apparatus 150 may further include at least one memory 1530, configured to store program instructions and/or data. The memory 1530 is coupled to the processor 1520. The coupling in this embodiment may be an indirect coupling or a communication connection between apparatuses, units, or modules, may be in an electrical, a mechanical, or another form, and is used for information exchange between the apparatuses, the units, or the modules. The processor 1520 may cooperate with the memory 1530. The processor 1520 may execute the program instructions stored in the memory 1530. At least one of the at least one memory may be included in the processor.

After the communication apparatus 150 is powered on, the processor 1520 may read the software program in the memory 1530, interpret and execute instructions of the software program, and process data of the software program. When data needs to be sent wirelessly, the processor 1520 performs baseband processing on the to-be-sent data, and then outputs a baseband signal to a radio frequency circuit (not shown in the figure). The radio frequency circuit performs radio frequency processing on the baseband signal, and then sends, a radio frequency signal in an electromagnetic wave form through an antenna. When data is sent to the communication apparatus 150, the radio frequency circuit receives the radio frequency signal through the antenna, converts the radio frequency signal into a baseband signal, and outputs the baseband signal to the processor 1520; and the processor 1520 converts the baseband signal into data and processes the data.

In another implementation, the radio frequency circuit and the antenna may be disposed independently of the processor 1520 that performs baseband processing. For example, in a distributed scenario, the radio frequency circuit and the antenna may be disposed remotely and independent of the communication apparatus.

In this embodiment, a connection medium between the communication interface 1510, the processor 1520, and the memory 1530 is not limited. In this embodiment, in FIG. 15 the memory 1530, the processor 1520, and the communication interface 1510 are connected through a bus 1540. The bus is represented by using a thick line in FIG. 15. A connection manner between other components is only schematically described and is not limited herein. The bus may be classified into an address bus, a data bus, a control bus, and the like. For ease of representation, only one thick line is used to represent the bus in FIG. 15, but this does not mean that there is only one bus or only one type of bus.

When the communication apparatus 150 is an apparatus used in the first wireless device or the second wireless device, for example, when the communication apparatus 150 is a chip or a chip system, the communication interface 1510 may output or receive a baseband signal. When the communication apparatus 150 is the first wireless device or the second wireless device, the communication interface 1510 may output or receive a radio frequency signal. In this embodiment, the processor may be a general-purpose processor, a digital signal processor, an application-specific integrated circuit, a field programmable gate array or another programmable logic device, a discrete gate or a transistor logic device, or a discrete hardware component, and may implement or perform the methods, operations, and logical block diagrams in this embodiment. The general-purpose processor may be a microprocessor, any conventional processor, or the like. The operations in the methods with reference to the embodiments may be directly performed and completed by a hardware processor or may be performed and completed by a combination of hardware in the processor and a software module.

An embodiment may further provide a non-transitory computer-readable storage medium. The non-transitory computer-readable storage medium stores instructions. When the instructions run on a processor, method procedures in the foregoing method embodiments are implemented.

An embodiment may further provide a computer program product. When the computer program product runs on a processor, the method procedures in the foregoing method embodiments are implemented.

It should be noted that, for brief description, the foregoing method embodiment is represented as a combination of a series of actions. However, a person skilled in the art should understand that the embodiments may not be limited to the described order of the actions, because some operations may be performed in other orders or simultaneously. It should be further appreciated by a person skilled in the art that the embodiments described all are just embodiments, and the involved actions and modules are not necessarily required.

The descriptions of the embodiments may be referred to separately as the descriptions of embodiments have different focuses. For a part not described in detail in an embodiment, refer to related descriptions of another embodiment. For ease of description and brevity, for functions of the apparatuses and devices provided in embodiments and operations performed by the apparatuses and devices, refer to related descriptions of the method embodiments. The method embodiments and the apparatus embodiments may also be mutually referenced, combined, or cited.

Finally, it should be noted that the foregoing embodiments are merely intended for describing rather than limiting. Although described in detail with reference to the foregoing embodiments, a person of ordinary skill in the art should understand that they may still make modifications to the foregoing embodiments without departing from the scope of the solutions of the embodiments.

1. A method for sending a measurement packet, comprising:
sending, by a first wireless device, a trigger frame, wherein the trigger frame is used to trigger a plurality of second wireless devices to send measurement packets in an orthogonal frequency division multiple access (OFDMA) manner; and
receiving, by the first wireless device, the measurement packets sent by the plurality of second wireless devices in the OFDMA manner.

2. The method for sending a measurement packet according to claim 1, wherein the trigger frame comprises first indication information; and
the first indication information indicates a group of tones with discontinuous frequencies that is occupied by the measurement packet; or
the first indication information indicates a resource unit (RU) occupied by the measurement packet.

3. The method for sending a measurement packet according to claim 2, wherein a manner in which the first indication information indicates the group of tones with discontinuous frequencies that is occupied by the measurement packet, the first indication information indicates an offset value of a non-zero tone and a spacing between adjacent non-zero tones, and the non-zero tone is a tone occupied by the measurement packet.

4. The method for sending a measurement packet according to claim 2, wherein the first indication information is located in a user information field in the trigger frame.

5. The method for sending a measurement packet according to claim 2, wherein the trigger frame further comprises second indication information, and the second indication information indicates a type of the measurement packet; and
when the first indication information indicates the group of tones with discontinuous frequencies that is occupied by the measurement packet, the type of the measurement packet is the measurement packet that occupies the group of tones with discontinuous frequencies; or
when the first indication information indicates the RU occupied by the measurement packet, the type of the measurement packet is the measurement packet that occupies the RU.

6. The method for sending a measurement packet according to claim 5, wherein the trigger frame comprises a common information field and the second indication information is located in the common information field.

7. The method for sending a measurement packet according to claim 1, wherein the trigger frame further comprises third indication information indicating that a type of the trigger frame is a wireless sensing type.

8. A method for sending a measurement packet, comprising:
receiving, by a second wireless device, a trigger frame sent by a first wireless device, wherein the trigger frame is used to trigger the second wireless device to send a measurement packet in an orthogonal frequency division multiple access (OFDMA) manner; and
sending, by the second wireless device, the measurement packet to the first wireless device in the OFDMA manner.

9. The method for sending a measurement packet according to claim 8, wherein the trigger frame comprises first indication information; and
the first indication information indicates a group of tones with discontinuous frequencies that is occupied by the measurement packet; or
the first indication information indicates a resource unit (RU) occupied by the measurement packet.

10. The method for sending a measurement packet according to claim 9, wherein the first indication information indicates the group of tones with discontinuous frequencies that is occupied by the measurement packet, the first indication information indicates an offset value of a non-zero tone and a spacing between adjacent non-zero tones, and the non-zero tone is a tone occupied by the measurement packet.

11. The method for sending a measurement packet according to claim 9, wherein the first indication information is located in a user information field in the trigger frame.

12. The method for sending a measurement packet according to claim 9, wherein the trigger frame further comprises second indication information indicating a type of the measurement packet; and
when the first indication information indicates the group of tones with discontinuous frequencies that is occupied by the measurement packet, the type of the measurement packet is the measurement packet that occupies the group of tones with discontinuous frequencies; or
when the first indication information indicates the RU occupied by the measurement packet, the type of the measurement packet is the measurement packet that occupies the RU.

13. The method for sending a measurement packet according to claim 12, wherein the trigger frame comprises a common information field, and the second indication information is located in the common information field.

14. The method for sending a measurement packet according to claim 8, wherein the trigger frame further comprises third indication information indicating that a type of the trigger frame is a wireless sensing type.

15. A communication apparatus, comprising a processor and a communication interface, wherein
the communication interface is configured to communicate with another communication apparatus, and the processor is configured to run a program, so that the communication apparatus implements the method:
sending, a trigger frame, wherein the trigger frame is used to trigger a plurality of second wireless devices to send measurement packets in an orthogonal frequency division multiple access (OFDMA) manner; and
receiving, the measurement packets sent by the plurality of second wireless devices in the OFDMA manner.

16. The communication apparatus according to claim 15, wherein the trigger frame comprises first indication information; and
the first indication information indicates a group of tones with discontinuous frequencies that is occupied by the measurement packet; or
the first indication information indicates a resource unit (RU) occupied by the measurement packet.

17. The communication apparatus according to claim 16, wherein the first indication information indicates the group of tones with discontinuous frequencies that is occupied by the measurement packet, the first indication information indicates an offset value of a non-zero tone and a spacing between adjacent non-zero tones, and the non-zero tone is a tone occupied by the measurement packet.

18. The communication apparatus according to claim 17, wherein the first indication information is located in a user information field in the trigger frame.

19. The communication apparatus according to claim 17,
wherein the trigger frame further comprises second indication information indicating a type of the measurement packet; and
when the first indication information indicates the group of tones with discontinuous frequencies that is occupied by the measurement packet, the type of the measurement packet is the measurement packet that occupies the group of tones with discontinuous frequencies; or
when the first indication information indicates the RU occupied by the measurement packet, the type of the measurement packet is the measurement packet that occupies the RU.
